(19) United States
(12) Patent Application Publication
(10) Pub. No.: US 2007/0294598 A1
(43) Pub. Date: Dec. 20, 2007

(54) Hard disk drive with built-in mirror

(75) Inventors: David W. Anderson, Sergeant Bluff, IA (US); Glenn Jystad, Dove Canyon, CA (US)

Correspondence Address: GATEWAY, INC.;ATTN: Patent Attorney, 610 GATEWAY DRIVE, MAIL DROP Y-04, N. SIOUX CITY, SD, 57049, US

(73) Assignee: Gateway Inc.

(21) Appl. No.: 11/440,340

(22) Filed: May 24, 2006

(51) Int. Cl. G06F 11/00

(52) U.S. Cl. 714/54

(57) ABSTRACT

Methods and systems are provided for mirroring data within a single hard drive. A hard disk drive (210) can receive a write command to write data on platters (216) therein. The data is then written in two locations (212, 214) using two different read/write heads. Additionally, hard disk drive (210) can receive a read command and reading the data from a first location (212) of the two locations (212, 214), if no drive read error is detected. If the drive read error is detected then the data can be read from a second location (214) of the two locations (214, 216), if the auto-mirror function is enabled.

### BACKGROUND

1. Field

The present invention relates to disk drives and more specifically a hard disk drive with internal data mirroring capability.

2. Background

Storage capacity has been increasing on hard disk drives as the cost of this storage has been decreasing. However, hard disk drives being mechanically based (i.e., having rotating platters and moving read/write heads) still have mechanical failure modes in addition to the electrical failure modes. For example, a read/write head may contact the surface of a platter and thus damage the read/write head and/or the platter surface causing a loss of stored data. In particular, the possibility of mechanical failures can be increased when the device is subject to vibration and shock while operating. For example, in a portable device (e.g., a laptop computer) the hard disk drive may be operating while the device is in motion and subject to increased shock and vibration due to the mobile environment (e.g., in an airplane, automobile and the like).

Conventional systems can use Redundant Array of Independent (or Inexpensive) Disks (RAID) to address some of the failure concerns and to improve the fault tolerance/reliability of the data stored thereon. There are various levels (e.g., RAID 1 to RAID 7) of RAID systems that each have unique features, however, all these systems require at least two drives. FIG. 1 illustrates a conventional RAID 1 system 100. RAID 1 is disk mirroring and duplexing, requiring a minimum of two drives 110, 120. The drives 110, 120 are used in pairs and all data 112, 122 is written identically to both drives. As illustrated, the data 112, 122 does not have to be written to identical physical locations of each drive 110, 120. The RAID controller 104 interfaces to a system 102 supplying the data (e.g., a personal computer). Further, each drive can be duplexed by being connected to its own interface controller which may be part of the RAID controller 104 or another device. Therefore, the failure of one drive (e.g., 110) will not bring down the system 102. Instead the other drive (e.g., 120) will continue to operate.

Although RAID systems can improve the effective reliability of a hard disk drive based storage system, it comes at increased cost and complexity. For example, two drives are now used for the equivalent storage capacity of one drive which increases the power and space consumed by these systems, as well as increasing the cost.

### SUMMARY

Embodiments disclosed herein address the above stated needs by providing systems and methods for mirroring data written to a platter within the hard disk drive itself.

Accordingly, an embodiment of the invention can include a method comprising: receiving a write command to write data at a hard disk drive; and writing the data in two locations using two different read/write heads of the hard disk drive.

Another embodiment of the invention can include a hard disk drive comprising: logic configured to receive a write command to write data; and logic configured to write the data in two locations using two different read/write heads of the hard disk drive.

### BRIEF DESCRIPTION OF THE DRAWINGS

The accompanying drawings, which are incorporated in and constitute part of the specification, illustrate various embodiments of the invention. Together with the general description, the drawings serve to explain the principles of the invention. In the drawings:

FIG. 1 depicts a conventional RAID system.

FIGS. 2A and 2B depict exemplary systems for implementing various embodiments of the invention.

FIG. 3 depicts additional detail of a hard disk drive in accordance with at least one embodiment of the invention.

FIG. 4 depicts an exemplary flowchart illustrating data writing methods in accordance with at least one embodiment of the invention.

FIG. 5 depicts an exemplary flowchart illustrating data reading methods in accordance with at least one embodiment of the invention.

FIG. 6 depicts an exemplary flowchart illustrating storage space recovery methods in accordance with at least one embodiment of the invention.

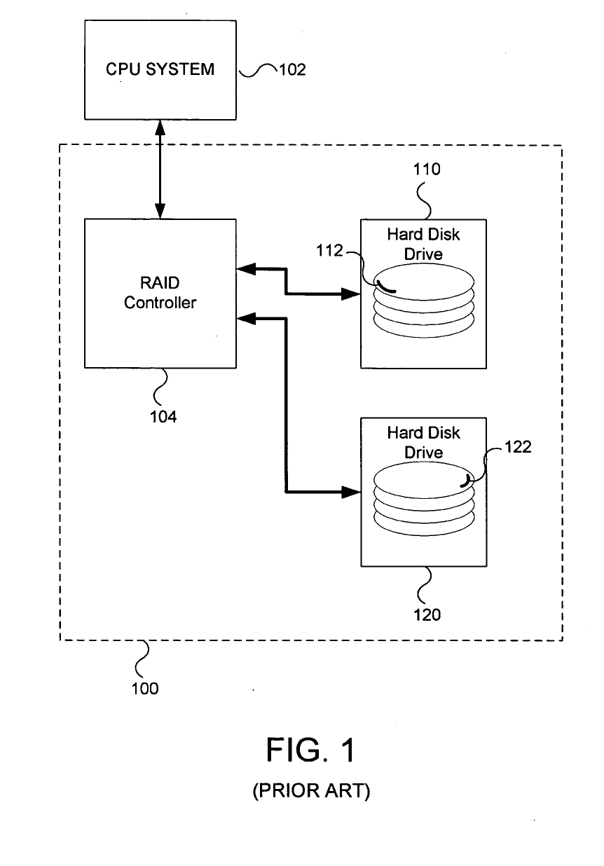

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

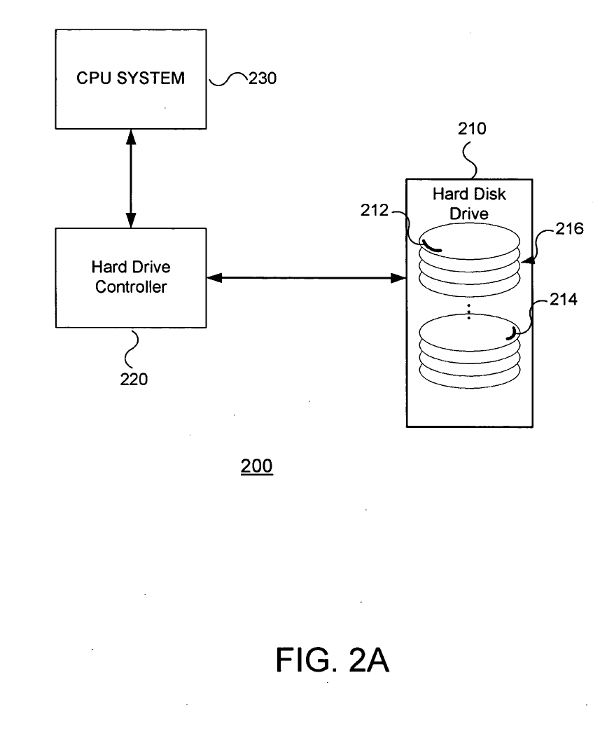

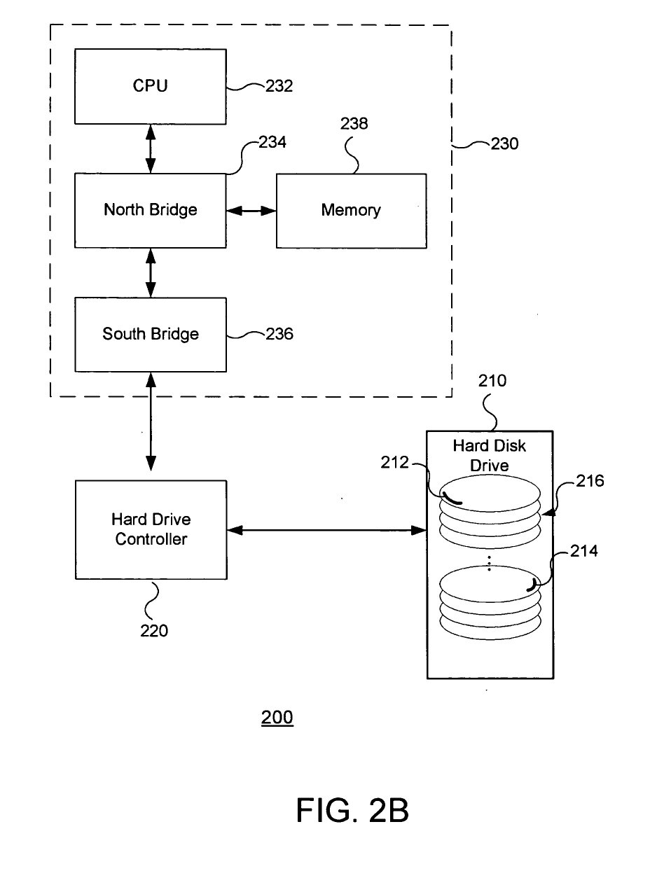

Referring to FIG. 2A, an exemplary system 200 according to at least one embodiment of the invention is illustrated. In contrast to the RAID system discussed in the Background, embodiments of the invention can have a single hard disk drive 210 that mirrors data (e.g., 212, 214) to different hard disk platters 216 in the hard disk drive. Accordingly, a single hard disk drive 210 can function similar to the RAID system described in the Background. Additionally, hard drive controller 220 can be a conventional controller that interfaces to processor system 230 to store and retrieve data. This allows for systems to be upgraded without the need for specialized controllers.

For example, as illustrated in FIG. 2B, the processor system can include a conventional Northbridge/Southbridge configuration as used in many personal computer configurations. The central processing unit (CPU) 232 can communicate to the Northbridge 234 via a high speed data bus. Additionally, the Northbridge 234 can connect the CPU 232 to memory 238 and Southbridge 236. Further, the Northbridge logic 234 can connect the CPU to other devices/interfaces such as, Level 2 cache memory, AGP bus/devices and the like, which are well known in the art and not shown to simplify the illustration. In Northbridge/Southbridge architectures, the Southbridge typically includes logic that controls the computer's I/O functions, such as USB, audio, the system BIOS, the PCI bus, the interrupt controller and the IDE/SATA channels, also not shown to simplify the illustration. The IDE/SATA interface can be used to communicate to the hard disk controller 220 as illustrated. Accordingly, a conventional personal computer (e.g. desktop, laptop) including conventional hard drive controllers can be used in embodiments of the invention.

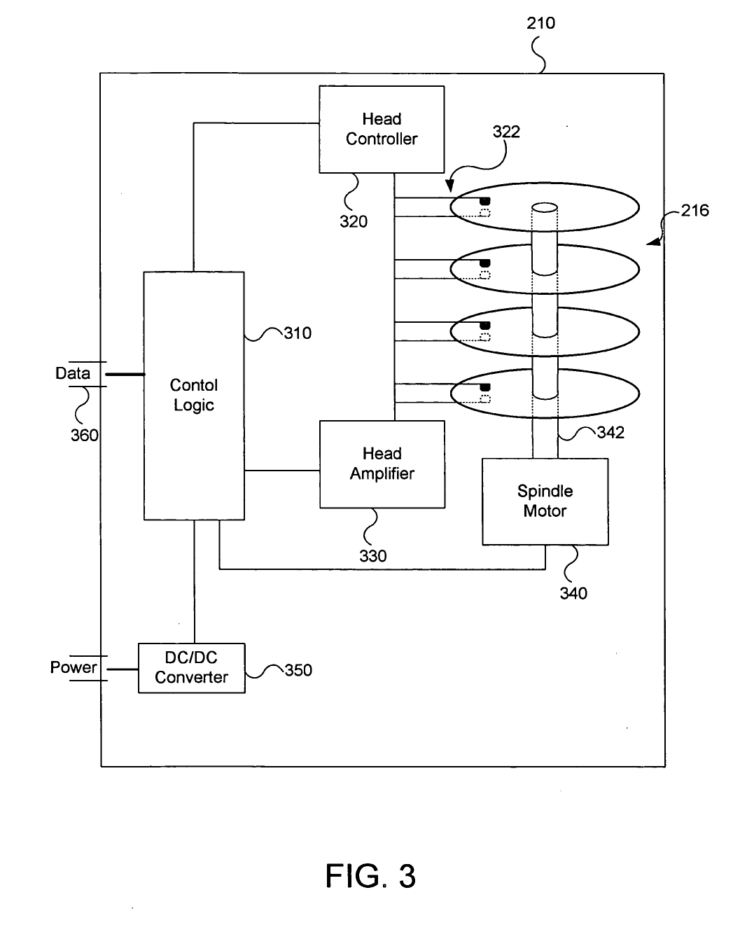

FIG. 3 provides a more detailed view of hard disk drive 210. As illustrated therein, the hard disk drive 210 includes drive control logic 310, a head controller 320, read/write heads 322, head amplifier 333, spindle motor 340, and DC/DC converter 350 among other components as is known in the art. Once again, not all components of a hard disk drive or functional aspects thereof will be discussed herein as these are well known in the art. The spindle motor 340 drives spindle 342, which in turn causes the simultaneous rotation of platters 216. Data communicated from interface 360 is then read and written by moving read/write heads 322 over the rotating platters 216. The read/write process can be performed by head controller 320 and head amplifier 330 as is known in the art. Since modern hard disk drives have greatly increased capacity, including multiple platters and associated read/write heads, in one embodiment of the invention the platters are divided into a primary drive and a mirror drive. For example, in a hard disk drive having ten physical platters, the first five platters can be used as the primary drive and the second five platters can be used as the mirror drive. Alternatively, the top read/write head can be assigned to the primary drive and the bottom read/write head could be assigned to the mirror drive. Those skilled in the art will appreciate many ways to divide the physical media into a primary and mirror drive. Accordingly, the invention is not limited to any specific scheme for dividing into a primary drive and mirror drive.

For purposes of illustration, assume the drive is configured so that the top read/write heads are designated as the primary drive and the bottom read/write heads are designated as the mirror drive. When data is written to the hard disk drive 210 from CPU system 230, the data will be automatically mirrored on both the top and bottom of a platter 216 within the hard disk drive 210. Likewise, when data is read from the hard disk drive 210 the data can be read from the appropriate location via top read/write head and communicated to CPU system 230. Accordingly, the processes can be the same as a conventional hard disk drive, when viewed from CPU system 230 and hard disk controller 220. Additional details regarding the read and write operation are provided in the following description.

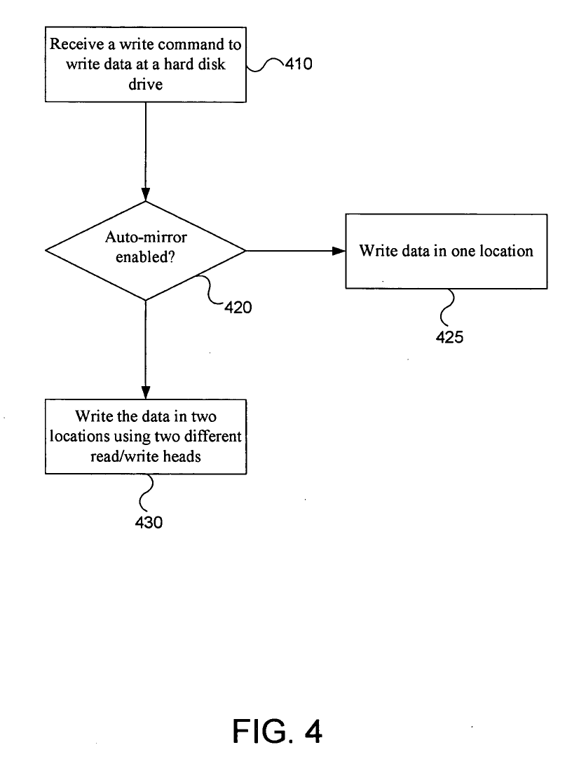

Referring to FIG. 4, a flowchart illustrating an embodiment of the invention is provided. The process starts in block 410, by the hard disk drive receiving a command to write data (e.g., sent by system 230 via hard disk controller 220). Upon receiving the command, the disk drive can then write the data in two locations using two different read/write heads, block 430. In another aspect of the invention, the hard disk drive can also be configurable to function both in a conventional manner and in an auto-mirror manner. Accordingly, a check can be performed prior to writing the data to determine if auto-mirroring is enabled, block 420. If the auto-mirroring is enabled, then the drive can write the data to the two locations (430). However, if the auto-mirroring is not enabled, then the data can be written to a single location in a conventional manner, block 425. The auto-mirroring function can be enabled via software and/or hardware settings, as will be appreciated by those skilled in the art. For example, the auto-mirror option can be selected by a jumper or switch set on the drive itself. Alternatively, the auto-mirror function can be set by software and communicated to the hard disk drive (e.g., from system 230/controller 220 via data interface 360). Further, a combination of hardware and software settings can be used. Accordingly, embodiments of the invention are not limited to these illustrations for enabling the auto-mirror function.

Accordingly, an embodiment of the invention can include a method including: receiving a write command to write data at a hard disk drive; and writing the data in two locations using two different read/write heads. Further, the method can include determining if auto-mirror is enabled; writing the data in the two locations if the auto-mirror is enabled; and writing the data to a single location if the auto-mirror is not enabled.

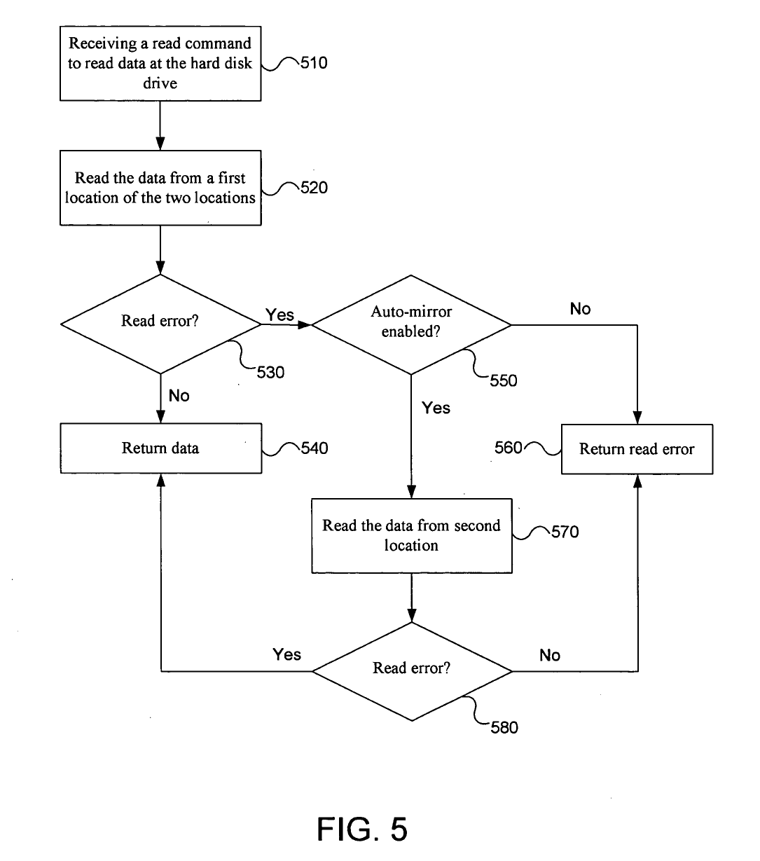

FIG. 5 is a flowchart illustrating another embodiment of the invention regarding the read process. The process begins by the receiving a read command to read data from the hard disk drive, block 510. Then, in block 520, the data is read from a first location (or single location if auto-mirror not enabled). If there is no read error, block 530, then the data is returned to the requesting system, block 540. However, if there is a read error detected, block 530, then the drive checks if the auto-mirror function is enabled, block 550. If the auto-mirror is not enabled, then a read error is returned, block 560. If the auto-mirror is enabled, then the data is read from the second location, block 570. For example, if a read error occurred when reading from the top read/write head and auto-mirror was enabled then the bottom read/write head could be used to attempt to read the data. If there is no read error, block 580, then the data is returned to the requesting system, block 540. Accordingly, the data will not be lost and the requesting system will not experience any disruption. At this time (one read error, one successful read), the hard disk drive could also alert the system of a possible pending drive failure. For example, using S.M.A.R.T. technology or other methods of logging the event. Additionally, the data related to the read error can be written to another portion of the hard disk drive to reestablish the mirror of this data. However, if a read error is detected, block 580, the read error message is returned, block 560, and the data in this location is not readable.

Accordingly an embodiment of the invention can include methods for reading data written in two locations using two read/write heads including: receiving a read command at the hard disk drive; and reading the data from a first location of the two locations, if no drive read error is detected. Further, the method can include determining if an auto-mirror is enabled; reading the data from a second location of the two locations, if the auto-mirror is enabled; and returning a read error message, if the auto-mirror is not enabled. Additionally, the read error message can be returned, if the data cannot be read from the second location.

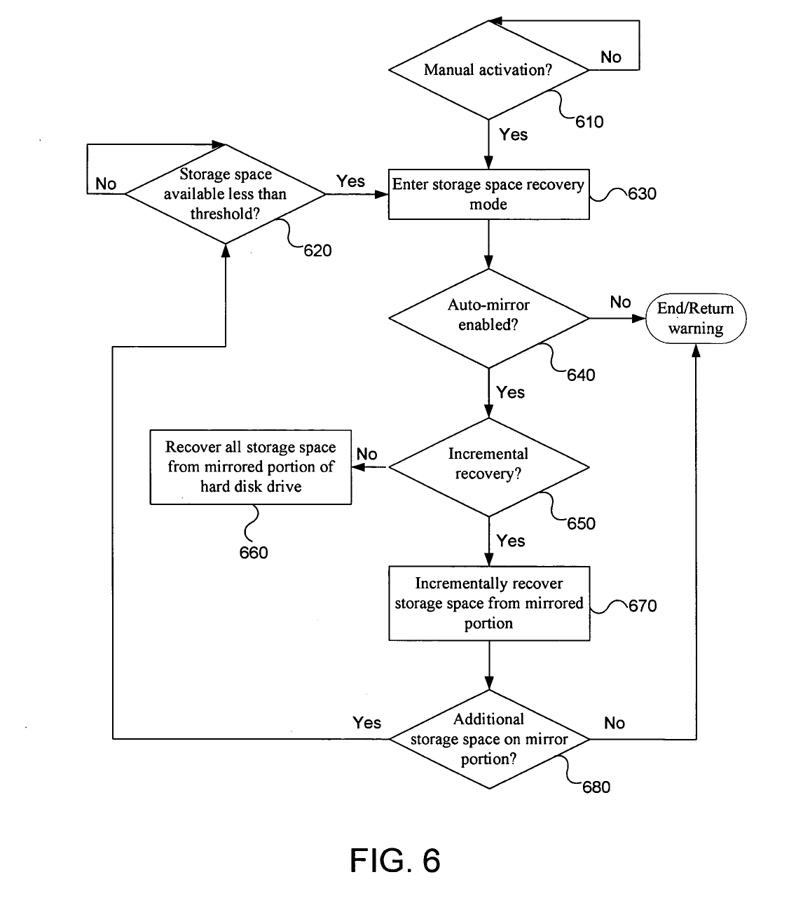

Although embodiments of the invention can improve the overall data reliability of the hard disk drive, it comes at the cost of reducing the effective size by half. For example, a 300 GB hard disk drive may appear to only have 150 GB of available storage space in embodiments of the invention. There can be situations where the freeing up the storage capacity used by the mirror portion is desired, even though it would result in the loss of the internal redundancy of the hard drive. For example, referring to FIG. 6, upon detection of a manual activation, block 610, the hard disk drive can enter a storage space recovery mode, block 630. For example, a user could manually select an option in a driver loaded into CPU system that sends a command to the hard disk drive. In addition or alternatively, the driver can monitor the storage space (e.g., in bytes, sectors and the like) available on the hard disk drive and determine if the available storage space is less than a specified threshold value, block 620. If the available storage space is less than the threshold, block 620, then the process can enter the storage space recovery mode, block 630. Next it can be determined if the auto-mirror is enabled, block 640. If the auto-mirror is enabled, then storage space can be recovered from the mirror portion of the hard disk drive. In block 650, an optional incremental recovery mode can be checked. If the incremental recovery mode is not selected or enabled, then the all storage space can be recovered from the mirror portion of the hard disk drive, block 660. However, if the incremental recovery mode is selected, then storage space from the mirror portion of the hard drive can be recovered in an incremental manner leaving some data mirrored and some not mirrored. For example, storage space can be recovered as need in predetermined increments (e.g., bytes, sectors, tracks and the like). Accordingly, upon recovering the predetermined portion, block 670, then the process can determine if there is any additional storage space to recover from the mirror portion and allocated to the primary portion, block 680. If there is no additional storage space, then the process ends and/or returns storage space warning. If there is additional storage space, then the process can return to block 620 to monitor available storage space. As will be appreciated by those skilled in the art the available storage space is determined by the primary portion of the hard disk drive as the storage space available on the primary portion will be what is detected by the CPU system.

Accordingly, embodiments of the invention can further include recovering storage space from a mirrored portion of the hard disk drive and adding the storage space to a primary portion of the hard disk drive, upon entering a storage space recovery mode. As discussed above, the storage space recovery mode can be entered upon at least one of exceeding a hard disk drive usage threshold and manually selecting the storage space recovery mode. Further, embodiments of the invention can include incrementally recovering storage space from the mirrored portion of the hard disk drive.

Further, those skilled in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design-constraints imposed on the overall system. Skilled artisans may implement the described functionality in varying ways for each particular application, but such implementation decisions should not be interpreted as causing a departure from the scope of the present invention.

Thus, the foregoing steps, process, functions, algorithms and/or activities can be performed by specific circuits (e.g., application specific integrated circuits (ASICs)), by program instructions being executed by one or more processors, or by a combination of both. Thus, as previously discussed, the various aspects of the invention may be embodied in a number of different forms, which may be described as, “logic configured to” perform the described action. Additionally, the logic may be embodied in one discrete element or may be distributed over multiple elements. For example, the functions described herein can be embodied in the drive control logic 310 in FIG. 3 or may be embodied in other logic elements in the hard disk drive.

Accordingly, embodiments of the invention may be embodied as a hard disk drive including: logic configured to receive a write command to write data; and logic configured to write the data in two locations using two different read/write heads. Further, embodiments of the invention can include logic configured to determine if an auto-mirror is enabled; logic configured to write the data in the two locations, if the auto-mirror is enabled; and logic configured to write the data to a single location, if the auto-mirror is not enabled. Still further, embodiments of the invention can include logic configured to receive a read command at the hard disk drive; and logic configured to read the data from a first location of the two locations, if no drive read error is detected. The invention is not limited to these examples as will be appreciated by those skilled in the art and as previously stated, any of the foregoing steps, process, functions, algorithms and/or activities can be performed by appropriately configured logic.

The various steps, functions, or activities may be included or excluded as described above, or may be performed in an order different from that depicted in the figures, with the rest of the activities still remaining within the scope of at least one exemplary embodiment. For example, in some embodiments the auto-mirror function may not be selectable and therefore the check to see if auto-mirror is enabled would be unnecessary. Other optional decisions may also be eliminated, such as the incremental mode and/or the manual selection, and the like. Although the decision may be eliminated, it does not necessarily mean the feature is eliminated. For example, the incremental mode detection block 650 can be eliminated but the driver/hard disk drive can be configured to use only incremental recovery so that the functionality will be realized without the option for selecting and/or detecting the incremental mode.

Additionally, the invention may be implemented with any sort of processing units, processors and controllers capable of performing the stated functions and activities. For example, the controller may be embodied as a microprocessor, microcontroller, DSP, RISC processor, or any other type of processor or hardwired logic that one of ordinary skill would recognize as being capable of performing the functions described herein. A processing unit in accordance with some embodiments may operate computer software programs stored (embodied) on computer-readable medium such as the memory, flash memory, ram, or other computer readable medium as recognized by one of ordinary skill in the art. The computer software programs can aid or perform the steps and activities described above. For example, computer programs in accordance with at least one exemplary embodiment may include: source code for receiving a write command to write data at a hard disk drive; and writing the data in two locations using two different read/write heads. There are many further source codes that may be written to perform the stated steps and procedures above, and these are intended to lie within the scope of exemplary embodiments.

Further variation to embodiments of the invention can include reserving a portion of the drive to re-mirror failed reads. For example, a protect portion of the drive (e.g., 20 sectors) can be reserved for additional protection. If the protect portion exists and if a read fails on the primary data and succeeds on the mirrored data (see, e.g., FIG. 5, 710), the mirrored data can be written to the reserved location (720) and a translation table can be maintained for future reads (730). This feature can extend the life of a drive for critical data (e.g., data user accesses frequently).

Still further, another embodiment of the invention can include allowing a user to improve drive capacity by dividing the drive's total capacity into two segments, mirrored and non-mirrored. Operating system (OS) level partitions can be created to reflect each of these segments. One partition can be internally mirrored to protect its content and the other partition is not. With this configuration, the user can increase the effective capacity of the drive. For example, if ⅔ of the drive is allocated for mirroring and ⅓ is allocated for non-mirroring, both would have the same functional capacity and would only reduce the total capacity of the physical drive by ⅓ instead of ½. Critical and unique data can be placed on the protected partition (e.g., the OS to ensure booting and personal documents) and reproducible data can be placed on the unprotected partition (e.g., reference data and installed applications)

Accordingly, the description of the various exemplary embodiments provided I in the foregoing is illustrative in nature and is not intended to limit the invention, its application, or uses. Thus, variations that do not depart from the gist of the invention are intended to be within the scope of the embodiments of the present invention. Such variations are not to be regarded as a departure from the spirit and scope of the present invention.

What is claimed is:

1. A method comprising:
receiving a write command to write data at a hard disk drive; and
writing the data in two locations using two different read/write heads of the hard disk drive.

2. The method of claim 1, wherein the data is written to two different platters within the hard disk drive.

3. The method of claim 1, wherein the data is written to two different sides of a platter within the hard disk drive.

4. The method of claim 1, further comprising:
determining if an auto-mirror is enabled;
writing the data in the two locations, if the auto-mirror is enabled; and
writing the data to a single location, if the auto-mirror is not enabled.

5. The method of claim 1, further comprising:
receiving a read command at the hard disk drive; and
reading the data from a first location of the two locations, if no drive read error is detected.

6. The method of claim 5, further comprising:
determining if an auto-mirror is enabled, if the drive read error is detected;
reading the data from a second location of the two locations, if the auto-mirror is enabled; and
returning a read error message, if the auto-mirror is not enabled.

7. The method of claim 1, further comprising:
recovering storage space from a mirrored portion of the hard disk drive, upon entering a storage space recovery mode; and
adding the storage space to a primary portion of the hard disk drive.

8. The method of claim 7, wherein the storage space recovery mode is entered upon at least one of:
exceeding a hard disk drive usage threshold; and
manually selecting the storage space recovery mode.

9. The method of claim 7, further comprising:
incrementally recovering the storage space from the mirrored portion of the hard disk drive.

10. The method of claim 1, further comprising:
reserving a portion of the hard disk drive for additional protection;
writing data read from a second location to the portion, if a read from a first location fails and the read from the second location is successful; and
maintaining a translation table from the first location to the portion that contains the data.

11. The method of claim 1, further comprising:
allocating a first partition of the hard disk drive as a mirrored partition; and
allocating a second partition of the hard disk drive as a non-mirrored partition, wherein data written to the first partition is stored in the two locations and wherein data written to the second partition is stored in a single location.

12. A hard disk drive comprising:
logic configured to receive a write command to write data; and
logic configured to write the data in two locations using two different read/write heads of the hard disk drive.

13. The hard disk drive of claim 12, wherein the data is written to two different platters within the hard disk drive.

14. The hard disk drive of claim 12, wherein the data is written to two different sides of at least one platter within the hard disk drive.

15. The hard disk drive of claim 12, further comprising:
logic configured to determine if an auto-mirror is enabled;
logic configured to write the data in the two locations, if the auto-mirror is enabled; and
logic configured to write the data to a single location, if the auto-mirror is not enabled.

16. The hard disk drive of claim 12, further comprising:
logic configured to receive a read command at the hard disk drive; and
logic configured to read the data from a first location of the two locations, if no drive read error is detected.

17. The hard disk drive of claim 16, further comprising:
logic configured to determine if an auto-mirror is enabled, if the drive read error is detected;
logic configured to read the data from a second location of the two locations, if the auto-mirror is enabled; and
logic configured to return a read error message, if the auto-mirror is not enabled.

18. The hard disk drive of claim 12, further comprising:
logic configured to recover storage space from a mirrored portion of the hard disk drive, upon entering a storage space recovery mode; and
logic configured to add the storage space to a primary portion of the hard disk drive.

19. The hard disk drive of claim 18, wherein the storage space recovery mode is entered upon at least one of exceeding a hard disk drive usage threshold, and manually selecting the storage space recovery mode.

20. The hard disk drive of claim 18, further comprising:
logic configured to incrementally recover the storage space from the mirrored portion of the hard disk drive.
